(19) United States
(12) Patent Application Publication
(10) Pub. No.: US 2016/0032891 A1
(43) Pub. Date: Feb. 4, 2016

(54) WIND TURBINE AND METHOD FOR OPERATING A WIND TURBINE

(71) Applicant: Wobben Properties GmbH, Aurich (DE)

(72) Inventors: Kai Busker, Großefehn (DE); Alfred Beekmann, Wiesmoor (DE)

(21) Appl. No.: 14/842,413

(22) Filed: Sep. 1, 2015

Related U.S. Application Data
(63) Continuation of application No. PCT/EP2014/056783, filed on Apr. 4, 2014.

(30) Foreign Application Priority Data
Apr. 8, 2015 (DE) 10 2013 206 119.6

(51) Int. Cl. F03D 7/02; H02H 7/06; F03D 7/04; F03D 1/06; F03D 9/00

(52) U.S. Cl. CPC F03D 7/0264; F03D 1/06; F03D 9/002; F03D 7/0272; F03D 7/042; H02H 7/067; F03D 9/003

(57) ABSTRACT

The invention relates to a wind turbine that comprises a rotor (106) having at least two rotor blades (108), an electrical generator that is directly or indirectly coupled to the rotor (106) of the wind turbine and said generator generates electrical power while the rotor (106) rotates, and a control unit (120) for controlling the operation of the wind turbine. The control unit (120) activates a first malfunction operating mode if parameters of a supply network exceed or fall below a threshold value. The control unit (120) is embodied in the first operating mode for the purpose of reducing the rotational speed of the rotor (106) to zero and for the purpose of activating a consumer (400) in order to consume, by means of the consumer (400), the electrical power that is generated in the malfunction operating mode by means of the generator.

### CROSS-REFERENCES TO RELATED APPLICATIONS

This application is a continuation of International Application No. PCT/EP2014/056783, filed Apr. 4, 2014, which claims priority to German Application No. 10 2013 206 119.6, filed Apr. 8, 2013, the entire contents of both of which are incorporated herein by reference in their entirety for all purposes.

The present invention relates to a wind turbine and also a method for operating the wind turbine.

Wind turbines comprise a rotatable rotor that is set in a rotational movement by means of the force of the wind. The rotor is either connected directly or is connected by way of a transmission to an electrical generator that converts the rotational movement of the rotor into electrical power. The electrical power that is generated is supplied into a supply network. The supply network comprises a plurality of energy generating units (wind energy, coal power plant, solar energy etc.) and a multiplicity of consumers. The supply network comprises parameters such as by way of example a network frequency, a network voltage etc. One object of the operator of the supply network is to operate the supply network in such a manner that the parameters of the supply network (network voltage and network frequency) do not exceed or fall below specific threshold values.

In the case of specific malfunctions in the supply network, in other words if one of the parameters has exceeded or fallen below the threshold value, the operation of the wind turbine is influenced in such a manner that the wind turbine slows down, in other words that the rotational speed of the rotor of the wind turbine is reduced and where necessary the rotor is stopped so that no further electrical power is generated and supplied into the supply network. As a result of the large mass of the rotor of the wind turbine, the rotor of the wind turbine cannot be stopped immediately. In other words, if a malfunction occurs in the supply network, then the rotational speed of the rotor of the wind turbine is reduced for example as a result of rotor blades pitching (by virtue of changing the pitch angle). For this purpose, the rotor blades can be pitched or rather rotated in such a manner that a minimal contact surface with respect to the wind is provided. Since the rotor of the wind turbine continues to rotate even after a malfunction has occurred in the supply network, electrical power continues to be generated, even if in a reduced amount, in the wind turbine and said electrical power is output into the electrical supply network.

In the German patent application establishing priority, the German Patent and Trade Mark Office has researched the following documents: DE 10 2005 049 426 B4; US 2007/0100506 A1; U.S. Pat. No. 4,511,807 A; EP 2 075 890 A1; WO 99/50945 A1; US 2003/0193933 A1 and EP 2 621 070 A1.

One object of the present invention is to provide a wind turbine and a method for operating the wind turbine that can better react to malfunctions in a supply network to which the wind turbine is connected.

This object is achieved by means of a wind turbine and also by means of a method according to the claims.

As a consequence, a wind turbine is provided, said wind turbine comprising a rotor having at least two rotor blades, an electrical generator that is directly or indirectly coupled to the rotor of the wind turbine, and said generator generates electrical power while the rotor is rotating, and a control unit for controlling the operation of the wind turbine. The control unit activates a first malfunction operating mode if parameters of a supply network have exceeded or fallen below a threshold value. In the first malfunction operating mode, the control unit is embodied for the purpose of reducing the rotational speed of the rotor to zero and activating a chopper in order to consume, by means of the chopper, the electrical power that is generated in the malfunction operating mode by means of the electrical generator.

The invention likewise relates to a wind turbine comprising a rotor having at least two rotor blades, an electrical generator that is directly or indirectly coupled to the rotor and said generator generates electrical power while the rotor rotates, and a control unit for controlling the operation of the wind turbine. The control unit is embodied for the purpose of activating a second malfunction mode if parameters of the supply network exceed or fall below a threshold value. In the second malfunction mode, the control unit is embodied for the purpose of controlling the wind turbine in such a manner that said control unit draws power from the supply network and consumes said power by means of the chopper.

The invention relates to an idea of providing a wind turbine having a power cabinet that comprises power electronics such as for example an inverter. Furthermore, a chopper is provided in the power cabinet and said chopper is also coupled to a load resistor. The wind turbine comprises a control unit that reduces the rotational speed of the rotor of the wind turbine by means of changing the pitch angle of the rotor blades if a malfunction such as by way of example an over frequency is determined in the supply network. The rotational speed of the rotor is consequently reduced by means of the control unit. However, it is not possible to directly and immediately stop the rotor owing to the large mass of the rotor of the wind turbine. On the contrary, the wind turbine requires for example a few seconds to completely stop the rotor. During this time, the electrical generator that is coupled to the rotor further generates electrical power that is output to the supply network.

In accordance with the invention, the control unit can be switched into a malfunction operating mode if a malfunction (a parameter of the supply network exceeding or falling below a threshold value) occurs in the supply network. In the malfunction operating mode, the control device activates the chopper in order to convert the power that is generated by means of the generator into heat by way of the chopper and the at least one load resistor. The electrical power that is generated by means of the generator after the malfunction has been determined in the supply network of the wind turbine during the reduction of the rotational speed of the rotor is converted by way of the chopper into heat. As a consequence, it can be achieved that, after a malfunction has been determined in the supply network (in other words promptly), the wind turbine no longer supplies energy into the supply network.

This is in particular expedient if the malfunction is an over frequency in the network that illustrates that too much power is being supplied into the supply network or rather that not enough power is being consumed. In order to reduce the over frequency, it is necessary to either supply less energy into the supply network or to consume more energy from the supply network. As a result of activating the chopper in accordance with the invention for the purpose of converting the power of the wind turbine that is generated in the malfunction operating mode, it is possible very quickly, in other words practically immediately after a malfunction has been determined in the supply network, to stop the wind turbine supplying power into the supply network so that the wind turbine can react very very quickly to a malfunction in the supply network in particular in the case of an over frequency and as a consequence said wind turbine can intervene in such a manner that supports the network. In accordance with the invention, the power that is generated by a wind turbine can no longer be directly and promptly supplied into the supply network.

In accordance with one aspect of the present invention, for example in the case of a lack of wind and in the case of a malfunction in the supply network (by way of example an over frequency) the wind turbine can be used for the purpose of drawing power from the supply network and converting said power into heat by way of the chopper and the load resistor that is coupled to said chopper so that the wind turbine is then coupled as an electrical consumer to the supply network. As a consequence, electrical power can be drawn very quickly from the supply network by means of the wind turbine.

In accordance with a further aspect of the present invention, an energy supply company can influence the operation of the wind turbine. This can in particular occur in the case of a malfunction in the supply network. In accordance with the invention, a wind turbine can be shut down on demand by the energy supply company for example in the case of a malfunction in the supply network and the power that is generated during the shutting down process can be converted into heat in accordance with the invention by way of the chopper. It can therefore be achieved that the wind turbine is rapidly removed from the network and no further power is supplied into the supply network.

The method in accordance with the invention for operating the wind turbine can also be used if an overvoltage is determined in the network.

In accordance with a further aspect of the present invention, a change in frequency of the network frequency can be determined and the wind turbine can be shut down for example in the case of the change in frequency exceeding a threshold value and the power that is generated in this case can be converted into heat by means of the chopper and the load resistor. The power output can therefore be reduced to zero for example in case of an emergency.

Further embodiments of the invention are the subject matter of the dependent claims.

### BRIEF DESCRIPTION OF THE DRAWINGS

Advantages and exemplary embodiments of the invention are further explained hereinunder with reference to the drawing.

FIG. 1A illustrates a schematic illustration of a wind turbine in accordance with the invention,

FIG. 1B illustrates a schematic illustration of a wind farm in accordance with the invention,

FIG. 2 illustrates a graph for explaining the method in accordance with a first exemplary embodiment,

FIG. 3 illustrates a graph for explaining a method in accordance with a second exemplary embodiment of the invention and

FIG. 4 illustrates a graph for explaining the method in accordance with the invention.

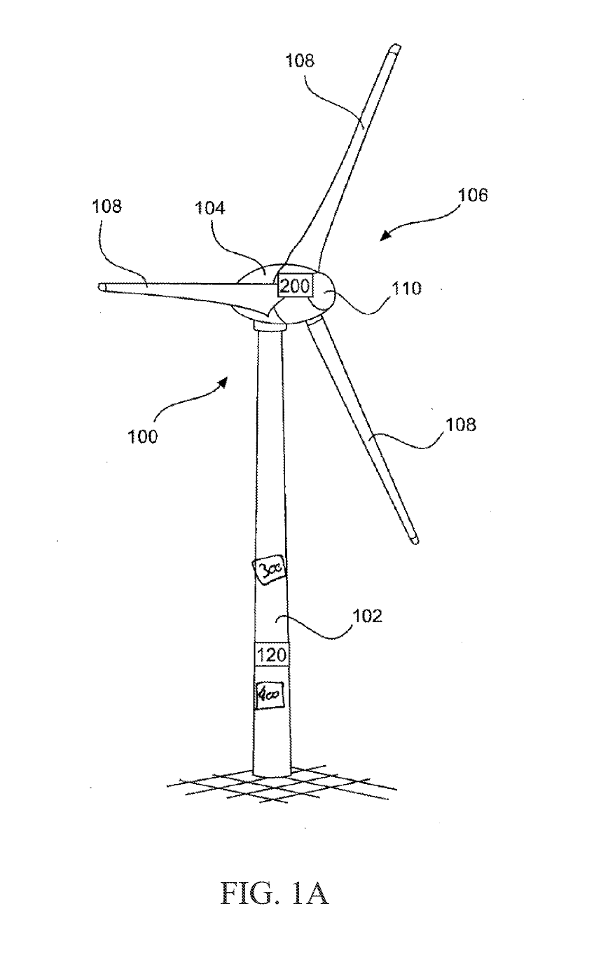

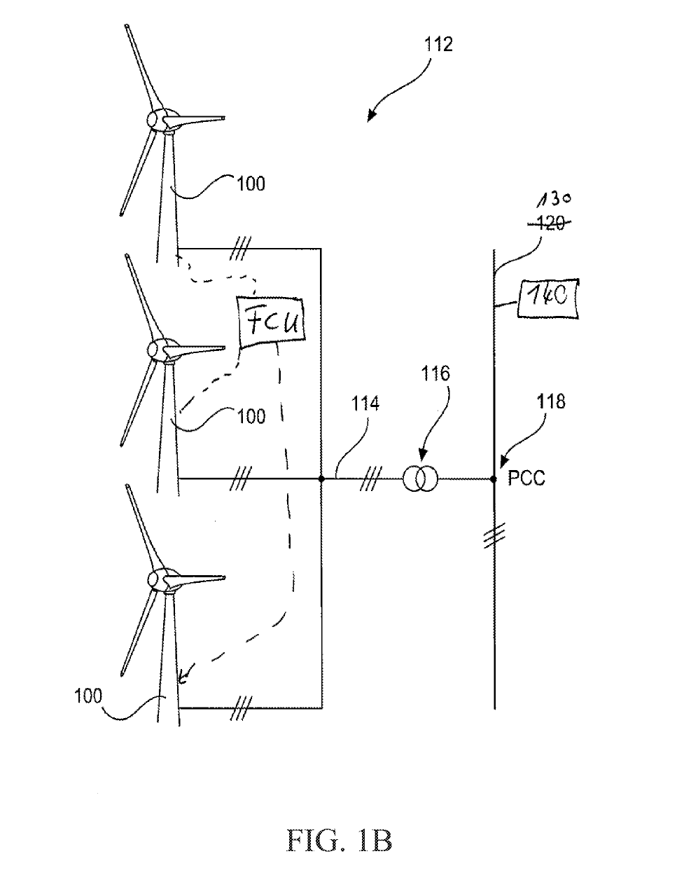

FIG. 1A illustrates a schematic illustration of a wind turbine in accordance with the invention.

FIG. 1A illustrates a schematic illustration of a wind turbine in accordance with the invention. The wind turbine 100 comprises a tower 102 and a housing 104. A rotor 106 that comprises three rotor blades 108 and a spinner 110 is provided on the housing 104. The rotor 106 is set in a rotational movement by means of the force of the wind during operation and as a consequence has an electrical generator in the housing 104. The pitch of the rotor blades 108 can be changed by means of pitch motors on the rotor blade base of the respective rotor blade 108.

Furthermore, the wind turbine 100 comprises a control unit 120 for controlling the operation of the wind turbine and an electrical consumer for example in the form of a chopper 400. The electrical consumer 400 is used for the purpose of consuming energy that the wind turbine has generated but cannot be output into the supply network, and in particular for the purpose of converting said energy into heat.

FIG. 1B illustrates a schematic illustration of a wind farm having multiple wind turbines. FIG. 1B illustrates in particular a wind farm 112 having three wind turbines 100 that can be identical or different. The three wind turbines 100 are representative of fundamentally any number of wind turbines 100 of a wind farm 112. The wind turbines 100 provide their power, namely in particular the current that is generated, by way of an electrical farm network 114. The respective generated currents or rather powers of the individual wind turbines 100 are summated and optionally, a transformer 116 can be provided that steps up the voltage in the farm network in order to then supply energy at the supply point 118 that is also in general described as the (point of common coupling) PCC into the supply network 130. FIG. 1B illustrates only a simplified illustration of a wind farm 112 that by way of example does not illustrate a control process although naturally a control process can be present. Optionally, a transformer can be provided at the output of each of the wind turbines 100.

In accordance with the invention, at least one wind turbine 100 is provided in accordance with the exemplary embodiment of the invention, in other words it is not necessary to provide a wind farm. The invention is however also applicable to a wind farm having multiple wind turbines.

Optionally, a measuring unit 140 can be coupled to the supply network 130 in order to determine the network frequency, the network voltage and/or a change in the network frequency or the network voltage.

In accordance with the invention, a consumer 400 for converting electrical energy for example into heat is provided. The consumer can by way of example be embodied as a chopper 400. The consumer can optionally comprise a control circuit in order to control the operation of the consumer.

The electrical consumer 400 can be provided in the wind turbine. Optionally, the electrical consumer 400 can also be provided centrally in a wind farm.

Optionally, a central wind farm control unit (farm control unit) FCU can be provided that can control the operation of the wind farm and the operation of the respective wind turbines. In accordance with the invention, the central wind farm control unit FCU can activate the first and/or second operating mode for each of the wind turbines. Optionally, the central wind farm control unit FCU can comprise a data input with which the energy supply company can control the central wind farm control unit FCU in such a manner that the first and/or second malfunction operating mode can be activated.

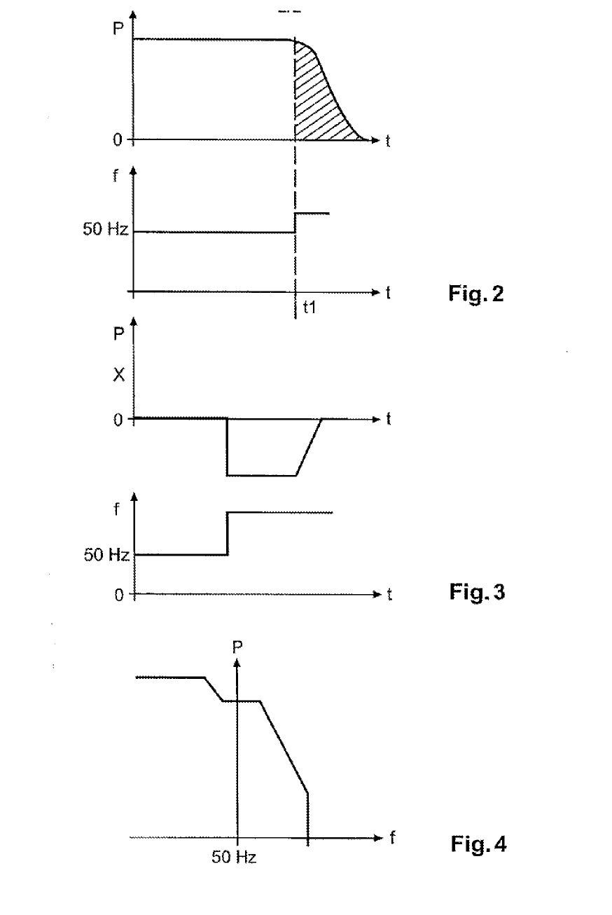

FIG. 2 illustrates a graph for explaining the method in accordance with a first exemplary embodiment. FIG. 2 illustrates the progression of the electrical power P that is output by means of the wind turbine over time and also the progression of the network frequency f over time. The wind turbine in accordance with the second exemplary embodiment can be based on the wind turbine that is illustrated in FIG. 1A. A malfunction occurs in the supply network at the point in time t1. The network frequency increases above the value 50 Hertz. After the point in time t1, the power that is output by means of the wind turbine is typically reduced to zero.

The wind turbine comprises a control unit 120 for controlling the operation of the wind turbine. The control unit 120 of the wind turbine obtains the prevailing parameters of a supply network either continually or at regular intervals. These parameters can by way of example represent the network voltage and the network frequency. The control unit 120 is embodied for the purpose of comparing these parameters with stored threshold values. If the determined parameters exceed or fall below the stored threshold values then the control unit 120 can switch into a malfunction operating mode.

In the malfunction operating mode, the wind turbine is controlled in such a manner that it no longer outputs electrical power to the supply network. For this purpose, typically the pitch angles of the rotor blades are changed in such a manner that the rotor blades are moved into the vane position (minimal contact surface with respect to the wind). The rotational speed of the rotor of the wind turbine is therefore reduced to zero. While the rotational speed of the rotor decreases to zero, the wind turbine will generate electrical power (illustrated as the hatched area in FIG. 2) as a result of the direct or indirect coupling of the rotor to the electrical generator of the wind turbine and said electrical power is output to the supply network.

In accordance with the invention, the control unit 120 is embodied for the purpose of likewise activating at least one consumer 400 (for example a chopper and a load resistor for example in a power cabinet of the wind turbine) if the malfunction operating mode is activated: The power cabinet of the wind turbine comprises in addition to the chopper 400 for example an inverter of the wind turbine. If the chopper 400 is activated in the power cabinet of the wind turbine in the case of the malfunction mode being activated (in other words in the case of a malfunction having been determined in the supply network) then the power of the electrical generator that is still generated while the rotational speed of the rotor is being reduced can be converted by way of example into heat by way of the consumer (chopper and the load resistor). It can therefore be achieved that the wind turbine no longer outputs power into the supply network as soon as the malfunction operating mode is activated (in other words as soon as a malfunction is determined in the supply network).

One example of a malfunction in the supply network is an over frequency (in other words the frequency in the supply network is above a limit frequency). In a case of this type, too much power is output into the supply network and too little power is drawn from the supply network. In order to reduce the over frequency, it is consequently necessary to reduce as quickly as possible the power that is output into the supply network. This can be achieved in accordance with the invention by means of activating the malfunction operating mode. After the malfunction operating mode has been activated, the wind turbine no longer outputs power into the supply network. The power that is generated by means of the wind turbine after the malfunction operating mode has been activated is then converted into heat in accordance with the invention by means of the consumer (chopper and the load resistor). As a consequence, it can be achieved in accordance with the invention that the power that is output by the wind turbine into the supply network is abruptly reduced to zero. As a consequence, a prompt reduction of the power that is output by the wind turbine into the supply network is rendered possible.

A further example of a malfunction is an internal malfunction of the wind turbine that renders it necessary to perform an emergency shutdown in other words an immediate shutdown.

FIG. 3 illustrates a graph for explaining a method for controlling the wind turbine in accordance with a second exemplary embodiment. In this exemplary embodiment, the wind turbine functions as a consumer in the supply network and as a consequence can draw power from the supply network and can convert said power into heat by means of the chopper.

In accordance with a second exemplary embodiment, the wind turbine can comprise a power consumption operating mode in accordance with the first exemplary embodiment. In this operating mode, the wind turbine can be connected to the supply network as a consumer and can draw power from the supply network. This power can then be converted into heat by means of the consumer 400 (chopper and the load resistor).

The power consumption operating mode can for example be activated by means of the control unit if there is a lack of wind (in other words, the wind turbine does not output any power to the supply network) and a malfunction arises in the supply network (such as by way of example an over frequency). As is described above, it is necessary in a case of this type either to reduce the power that is output to the supply network or to increase the power that is drawn from the supply network. In accordance with the second exemplary embodiment, the second option can be taken and the wind turbine can function as an electrical consumer and can draw electrical power from the supply network and said electrical power can be converted into heat by way of the chopper.

In accordance with a third exemplary embodiment, it is possible to activate the power consumption operating mode in accordance with the second exemplary embodiment by means of the control unit after the power output of the wind turbine has been reduced to zero in accordance with the first exemplary embodiment in the malfunction operating mode. In other words as soon as the power output of the wind turbine to the supply network has been reduced to zero, the control unit of the wind turbine can switch into the power consumption operating mode and can draw electrical power from the supply network and convert said electrical power into heat by means of the consumer (chopper).

The capability of the wind turbine to convert the power that is generated by the wind turbine into heat by means of the chopper is defined or rather limited in a malfunction operating mode as a result of the capacity of the consumer (choppers) and also the number of choppers that are used and also the load resistors. The amount of power that is to be consumed over a particular period of time by means of the chopper is particularly important in this case. If less power is to be consumed by means of the chopper or choppers then this is possible over a longer time period. However, if it is necessary to convert more power by way of example into heat by way of the chopper, then this can be performed in a shorter time period.

FIG. 4 illustrates a graph for explaining the relationship between the power that is output by the wind turbine and the network frequency. Provided that the frequency is within admissible threshold values, the maximum possible power P of the wind turbine is supplied into the supply network.

If the frequency is below the threshold value, then more power is to be output into the supply network. If the frequency is above a first threshold value, then the power that is output from the wind turbine into the electrical network is reduced incrementally. If the network frequency exceeds a second threshold value, then the wind turbine is slowed down and in accordance with the first exemplary embodiment, the electrical power that is generated as the wind turbine slows down is consumed by way of the consumer (chopper and a load resistor) and therefore said electrical power is not supplied into the supply network. As a consequence, after a second threshold value has been achieved, no further power is supplied into the supply network.

In accordance with a further exemplary embodiment, the wind turbine in accordance with the invention can comprise a (data) input 300 by way of which an energy supply company can influence the operation or rather control of the wind turbine. In this case, the wind turbine can be controlled in response to a demand from the energy supply company in such a manner that the wind turbine no longer outputs power into the supply network. This can occur in accordance with the first exemplary embodiment with the difference that no malfunction is determined in the supply network but rather that the malfunction operating mode is activated by means of the energy supply company.

The power consumption operating mode can likewise be activated by way of the energy supplier.

In accordance with a further aspect of the present invention, a change in frequency of the network can be monitored and if the change in frequency exceeds a threshold value, then the malfunction operating mode can be activated in accordance with the first exemplary embodiment. As a consequence, the wind turbine can react to an emergency such as for example a significant change in frequency of the network frequency.

In accordance with a further exemplary embodiment of the invention, a wind farm is provided with a plurality of wind turbines and a central wind farm control unit. The central wind farm control unit can be connected to the wind turbines by way of a data bus and can influence the control process of the wind turbine. For example, the central wind farm control unit (FCU) can therefore initiate an activation of the malfunction operating mode in accordance with the first exemplary embodiment.

The malfunction operating mode can therefore be activated in accordance with the first exemplary embodiment by means of the control unit of the wind turbine, by means of the central farm control unit or by means of the energy supply company.

1. Wind turbine, comprising:
a rotor having at least two rotor blades,
an electrical generator, that is directly or indirectly coupled to the rotor of the wind turbine and generates electrical power while the rotor rotates, and
a control unit for controlling the operation of the wind turbine, wherein the control unit activates a first malfunction operating mode, if parameters of a supply network exceed or fall below a threshold value,
wherein the control unit in the first malfunction operating mode is embodied for the purpose of reducing the rotational speed of the rotor to zero and for the purpose of activating an electrical consumer in order to consume, by means of the electrical consumer, the electrical power that is generated in the malfunction operating mode by means of the electrical generator.

2. Wind turbine according to claim 1, wherein
the parameters of the supply network represent the network frequency, the network voltage and/or the change in the network frequency or the network voltage and said parameters can be measured by means of a measuring unit that is coupled to the supply network.

3. Wind turbine, according to claim 1, comprising:
a rotor having at least two rotor blades,
an electrical generator that is coupled directly or indirectly to the rotor and generates electrical power while the rotor rotates, and
a control unit for controlling the operation of the wind turbine, wherein the control unit is embodied for the purpose of activating a second malfunction operating mode if parameters of the supply network exceed or fall below a threshold value,
wherein the control unit in the second malfunction operating mode is embodied for the purpose of controlling the wind turbine in such a manner that said control unit draws power from the supply network and consumes said power by means of the electrical consumer.

4. Wind turbine according to claim 1, further comprising:
a data input by way of which an energy supply company can influence the control process of the wind turbine.

5. Method for operating a wind turbine that comprises a rotor having at least two rotor blades, an electrical generator that is directly or indirectly coupled to the rotor and said generator generates electrical power while the rotor rotates, said method comprising the steps of:
activating a first malfunction operating mode by means of a control unit if parameters of a supply network exceed or fall below a threshold value, and
reducing the rotational speed of the rotor to zero and activating an electrical consumer, in order to consume, by means of the electrical consumer, the electrical power that is generated in the malfunction operating mode by means of the electrical generator.

6. Method for operating a wind turbine according to claim 5, further comprising the steps of:
activating a second malfunction operating mode by means of the control unit if parameters of the supply network exceed or fall below a threshold value, and
controlling the wind turbine so that said wind turbine draws power from the supply network and consumes said power by means of the electrical consumer.

7. Wind turbine according to claim 2, comprising:
a rotor having at least two rotor blades,
an electrical generator that is coupled directly or indirectly to the rotor and generates electrical power while the rotor rotates, and
a control unit for controlling the operation of the wind turbine, wherein the control unit is embodied for the purpose of activating a second malfunction operating mode if parameters of the supply network exceed or fall below a threshold value,
wherein the control unit in the second malfunction operating mode is embodied for the purpose of controlling the wind turbine in such a manner that said control unit draws power from the supply network and consumes said power by means of the electrical consumer.

8. Wind turbine according to claim 2, further comprising:
a data input by way of which an energy supply company can influence the control process of the wind turbine.

9. Wind turbine according to claim 3, further comprising:
a data input by way of which an energy supply company can influence the control process of the wind turbine.
